(19) United States
(12) Patent Application Publication
(10) Pub. No.: US 2026/0156472 A1
(43) Pub. Date: Jun. 4, 2026

(54) INTRUSION DETECTION IN COMPUTING DEVICES ONBOARD AN AIRCRAFT

(71) Applicant: Honeywell International Inc., Charlotte, NC (US)

(72) Inventors: Kirupakar J, Phoenix, AZ (US); Kalimulla Khan, Bangalore (IN); Robert Son, Phoenix, AZ (US); Angelo Koutsogiannis, Gilbert, AZ (US); Aaron Casterline, Florence, AZ (US)

(21) Appl. No.: 19/075,851

(22) Filed: Mar. 11, 2025

(30) Foreign Application Priority Data
Dec. 4, 2024 (IN) 202411095758

(51) Int. Cl. H04W 12/122

(52) U.S. Cl. CPC H04W 12/122

(57) ABSTRACT

Techniques for detecting intrusion in computing devices onboard an aircraft are described. In an example, data traffic associated with a computing device onboard an aircraft is monitored, where the data traffic originates from at least one source device coupled to the computing device. The data traffic may then be analyzed using an intruder detection machine learning model to identify an anomalous data pattern. Upon identification of the anomalous data pattern, an anomalous source device from the at least one source device corresponding to the anomalous data pattern may be identified. Subsequently, a notification indicative of a potential security breach associated with the anomalous source device may be generated.

### BACKGROUND

In recent years, aviation industry has witnessed a remarkable transformation with widespread adoption of onboard computing devices and connectivity solutions. Adoption of the onboard computing devices and connectivity solutions has brought numerous benefits to aircraft operations, including improved communication, enhanced navigation capabilities, and real-time access to critical information. For instance, Electronic Flight Bags (EFBs) have largely replaced traditional paper-based flight manuals and charts, providing pilots with digital access to critical flight information, weather updates, and performance calculations, thereby reducing cockpit clutter, decreasing the risk of outdated information, and allowing for rapid updates to flight-related data. Similarly, advances in Flight Management Systems (FMS) have resulted in improved route optimization, fuel efficiency calculations, and integration with other onboard systems, thereby enhancing overall flight performance and reducing operational costs.

### SUMMARY

According to a first aspect, a method for detecting intrusion in computing devices onboard an aircraft is disclosed. In an example, the method comprises: monitoring data traffic associated with a computing device onboard an aircraft, wherein the data traffic originates from at least one source device coupled to the computing device; analyzing the data traffic using an intruder detection machine learning model to identify an anomalous data pattern, the intruder detection machine learning model being trained using a training dataset comprising historical data traffic metrics and anomalous data patterns associated with the historical data traffic metrics; identifying an anomalous source device from the at least one source device corresponding to the anomalous data pattern; and generating a notification indicative of a potential security breach associated with the anomalous source device.

According to some examples, the training dataset further comprises synthetic data traffic metrics and probable anomalous data patterns associated with the synthetic data traffic metrics, the synthetic data traffic metrics and the probable anomalous data patterns being generated using the historical data traffic metrics and the anomalous data patterns.

According to some examples, the computing device is one of an Electronic Flight Bag (EFB) and Flight Management System (FMS).

According to some examples, the computing device is an Access Point (AP), and the at least one source device is at least one user device connected to the AP.

According to some examples, the historical data traffic metrics comprises information associated with volume of data, type of data, an intended destination of data, frequency of transmissions of data, port access requests, login attempts to different communication channels of the computing device, or a combination thereof.

According to some examples, the method further comprises: obtaining flight operation data for a predetermined time period prior to identification of the anomalous data pattern, the flight operation data is usable for managing flight operations of the aircraft; comparing the flight operation data with previous flight operation optimization data obtained during the predetermined time period to determine that the previous flight operation data is tampered; and replacing the previous flight operation data with the flight operation data.

According to some examples, the predetermined time period is determined based on a duration of communication session between the anomalous source device and the AP.

According to a second aspect, an Intruder Detection System (IDS) is disclosed. In an example, the IDS comprises: a training engine to: receive a training dataset comprising historical data traffic metrics associated with a computing device onboard an aircraft and anomalous data patterns associated with the historical data traffic metrics; and utilize the training dataset to train an intruder detection machine learning model for identifying an anomalous data usage pattern; an analysis engine coupled to the training engine to: monitor data traffic associated with the computing device, wherein the data traffic originates from at least one source device coupled to the computing device; analyze the data traffic using the intruder detection machine learning model to identify an anomalous data pattern; and identify an anomalous source device from the at least one source corresponding to the anomalous data pattern; and an intrusion notification engine coupled to the analysis engine to generate a notification indicative of a potential security breach associated with the anomalous source device.

According to some examples, the training dataset comprises synthetic data traffic metrics and probable anomalous data patterns associated with the synthetic data traffic metrics, the synthetic data traffic metrics and the probable anomalous data patterns being generated based on the historical data traffic metrics and the anomalous data patterns.

According to some examples, to generate the synthetic data traffic metrics and the probable anomalous data patterns, the training engine is to process the historical data traffic metrics and the anomalous data patterns using a generative machine learning model.

According to some examples, the generative machine learning model is one of Variational Autoencoder (VAE) and Generative Adversarial Network (GAN).

According to some examples, the computing device is one of an EFB and FMS.

According to some examples, the computing device is an AP, and the at least one source device is at least one user device connected to the AP.

According to some examples, the IDS further comprises an operations management engine to: obtain flight operation data for a predetermined time period prior to identification of the anomalous data pattern, the flight operation data being usable for managing flight operations of the aircraft; compare the flight operation data with previous flight operation data obtained during the predetermined time period to determine that the previous flight operation data is tampered; and replace the previous flight operation data with the flight operation data.

According to some examples, the operations management engine is to determine the predetermined time period based on a duration of communication session between the anomalous source device and the AP.

According to a third aspect, a non-transitory computer readable medium comprising computer-readable instructions that when executed cause a processing resource of a computing device to detect intrusion in computing devices onboard the aircraft is disclosed. In an example, the instructions cause the processing resource to receive historical data traffic metrics associated with at least one computing device onboard at least one aircraft and anomalous data patterns associated with the historical data traffic metrics; generate synthetic data traffic metrics and probable anomalous data patterns associated with the synthetic data traffic metrics, the synthetic data traffic metrics and the probable anomalous data patterns being generated based on the historical data traffic metrics and the anomalous data patterns; combine the historical data traffic metrics, the anomalous data patterns, the synthetic data traffic metrics, and the probable anomalous data patterns to generate a training dataset; utilize the training dataset to train an intruder detection machine learning model for identifying an anomalous data usage pattern; monitor data traffic associated with a computing device onboard an aircraft, wherein the data traffic originates from at least one source device coupled to the computing device; analyze the data traffic using the intruder detection machine learning model to identify an anomalous data usage pattern; and identify an anomalous source device from the at least one source device corresponding to the anomalous data usage pattern; and generate a notification indicative of a potential security breach associated with the anomalous source device.

According to some examples, to generate the synthetic data traffic metrics and probable anomalous data patterns, the instructions cause the processing resource to process the historical data traffic metrics and anomalous data patterns using a generative machine learning model, and the generative machine learning model being one of Variational Autoencoder (VAE) and Generative Adversarial Network (GAN).

According to some examples, the computing device is an AP, and the at least one source device is at least one user device connected to the AP.

According to some examples, the instructions further cause the processing resource to: obtain flight operation data for a predetermined time period prior to identification of the anomalous data pattern, the flight operation data is usable for managing flight operations of the aircraft; compare the flight operation data with previous flight operation data obtained during the predetermined time period to determine that the previous flight operation data is tampered; and replace the previous flight operation data with the flight operation data.

According to some examples, the instructions cause the processing resource to determine the predetermined time period based on a duration of communication session between the anomalous source device and the AP.

### BRIEF DESCRIPTION OF DRAWINGS

FIG. 1 illustrates an environment for implementing Intrusion Detection System (IDS), in accordance with an example of the present subject matter.

FIG. 2 illustrates an environment for implementing the IDS, in accordance with another example of the present subject matter.

FIG. 3 illustrates schematics of the IDS, in accordance with an example of the present subject matter,

FIG. 4 illustrates the schematics of the IDS, in accordance with another example of the present subject matter.

FIG. 5 illustrates a method for detecting intrusion in computing devices onboard an aircraft, in accordance with an example of the present subject matter.

FIG. 6 illustrates the method for detecting intrusion in the computing devices onboard the aircraft, in accordance with another example of the present subject matter.

FIG. 7 illustrates the method for detecting intrusion in the computing devices onboard the aircraft, in accordance with yet another example of the present subject matter.

FIGS. 8A and 8B illustrate the method for detecting intrusion in the computing devices onboard the aircraft, in accordance with yet another example of the present subject matter.

FIG. 9 illustrates a non-transitory computer-readable medium for detecting intrusion in the computing devices onboard the aircraft, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Connectivity solutions have expanded beyond just cockpit operations. In-flight Wi-Fi and satellite communications have become increasingly common, allowing for real-time data exchange between the aircraft and ground operations. For instance, such connectivity solutions has enabled enhancement in communication between flight crews and airline operations centers, thereby facilitating better decision-making and resource allocation. Further, adoption of such connectivity solutions have resulted in improved maintenance operations through the transmission of aircraft health data to ground crews, allowing for proactive maintenance planning. Adoption of such connectivity solutions has further resulted in enhanced passenger experience through in-flight entertainment and internet access.

However, since the onboard computing devices store and process important flight-related data, i.e., data affecting aircraft operations, such onboard computing devices have become potential targets for malicious actors. For instance, if a malicious actor gains access to a network gateway forming an interface between the aircraft's internal network and external communication systems an onboard computing device, the malicious actor can intercept and tamper critical real-time data being utilized for managing the aircraft operations, resulting in erroneous flight plans being generated and uploaded to the avionics systems of the aircraft.

Further, if the malicious actor manages to gain access to a user device of a passenger onboard aircraft by exploiting vulnerabilities of an Access Point (AP) being utilized for providing internet connectivity to user devices onboard the aircraft, the malicious actor may access sensitive personal identifiable information of the passenger. Furthermore, certain aircraft architectures allow the AP or the network gateway to automatically download and transfer black box flight recording data upon landing of an aircraft. If the malicious actor manages to exploit the vulnerabilities of the AP, the malicious actor may deploy a malware within the architecture resulting in the loss or tampering of flight recording data which is critical for the investigation of in-flight incidents. Moreover, the malicious actor exploiting the vulnerabilities within the AP has a potential to access systems restricted to flight crew, such as in-flight announcement intercom. If the malicious actor manages to access such systems, the malicious actor could play specious announcements causing panic amongst the passengers and the flight crew.

According to examples of the present subject matter, techniques for detecting intrusion in computing devices onboard an aircraft are described.

In an example, data traffic associated with a computing device onboard an aircraft may be monitored. The data traffic may originate from at least one source device coupled to the computing device. The data traffic may then be analyzed using an intruder detection machine learning model to identify an anomalous data pattern. In an example, the intruder detection machine learning model may be trained using a training dataset including historical data traffic metrics and anomalous data patterns associated with the historical data traffic metrics. In the example, the training dataset may further include synthetic data traffic metrics and probable anomalous data patterns associated with the synthetic data traffic metrics. The synthetic data traffic metrics may be generated using the historical data traffic metrics. Upon identification of the anomalous data pattern, an anomalous source device from the at least one source device corresponding to the anomalous data pattern may be identified. Subsequently, a notification indicative of a potential security breach associated with the anomalous source device may be generated.

In an example, the computing device may be an Access Point (AP) and at least one source device may be at least one user device connected to the AP. In the example, the data traffic corresponding to the at least one user device may then be analyzed to identify an anomalous data pattern. If the anomalous data pattern is identified, it may be determined that a user of the at least one user device is a malicious actor. In such a situation, a notification indicative of a potential security breach associated with the at least one user device may be generated.

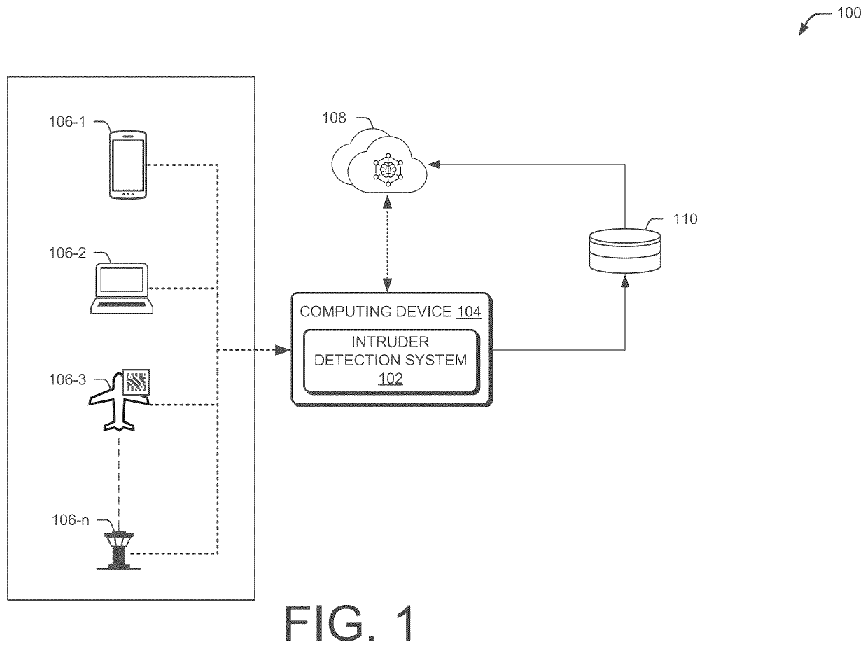

The above techniques are further described with reference to FIGS. 1 to 9. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment 100 for implementing an Intrusion Detection System (IDS) 102, in accordance with an example of the present subject matter. In an example, the IDS 102 may facilitate intrusion detection in computing devices onboard an aircraft.

The environment 100 may include a computing device 104 onboard the aircraft. Examples of the computing device 104 may include, but are not limited to, network gateways that interface between the aircraft's internal network and external communication systems, Electronic Flight Bag (EFB), Flight Management System (FMS), and Access Point (AP) for providing internet connectivity to at least one device onboard the aircraft. In the example, the IDS 102 may be implemented on the computing device 104. The IDS 102 may be implemented on the computing device 104 is various ways. In an example, the IDS 102 may be implemented on the computing device 104 as an application. In another example, the IDS 102 may be implemented on the computing device 104 as a routine of computing device's Operating System (OS).

The environment 100 may further include a plurality of source devices 106-1, 106-2, 106-3, . . . , 106-n connected to the computing device 104. For the ease of reference, the plurality of source devices 106-1, 106-2, 106-3, . . . , 106-n has been interchangeably referred to as the plurality of source devices 106, hereinafter. Examples of a source device from the plurality of source devices 106 may include, but are not limited to, user devices onboard the aircraft, avionics systems of the aircraft, and Air Traffic Control (ATC) systems.

The plurality of source devices 106 may be communicatively coupled to the computing device 104 via a communication network (not shown). The communication network can be a wireless or a wired network, or a combination thereof. Further, the communication network can be a collection of individual networks, interconnected with each other and functioning as a single large network. Examples of the communication network may vary depending on a type of a source device from the plurality of source devices 106. For instance, when the source device is a user device onboard the aircraft, the communication network may include onboard Wi-Fi. On the other hand, when the source device is an ATC system, the communication network may include satellite communication (SATCOM), Very High-Frequency (VHF) radio communications, or a combination thereof. Further, when the source device is an avionics system of the aircraft, the communication network may include an avionics data bus of the aircraft.

The environment 100 may further include an aviation cloud 108 connected to the computing device 104. In an example, the aviation cloud 108 may host an intruder detection machine learning model to analyze data traffic associated with the computing device 104 and identify an anomalous data usage pattern from the data traffic. In the example, the intruder detection machine learning model may be trained based on a training dataset created using the historical data traffic metrics associated with at least one computing device onboard at least one aircraft. In another example, instead of being trained and hosted on the aviation cloud 108, the intruder detection machine learning model may be trained and hosted on the computing device 104. The manner in which the intrusion detection machine learning model is trained on the computing device 104 and the aviation cloud 108 may similar. Accordingly, details related to training of the intrusion detection machine learning model on the computing device 104 are not described for the sake of brevity.

In an example, the environment 100 may further include a data repository 110 communicatively coupled to the computing device 104. In the example, to train the intruder detection machine learning model, the historical data traffic metrics may be collected from the computing device 104 available onboard the aircraft, along with other similar computing devices onboard different aircrafts and stored in the data repository 110. The historical data traffic metrics may then be processed to identify anomalous data patterns associated with the historical data traffic metrics. In an example, the historical data traffic metrics may be processed based on a plurality of rules supplied by flight safety crew to identify the anomalous data patterns. The historical data traffic metrics and the anomalous data patterns associated with the historical data traffic metrics may then be transmitted to the aviation cloud 108 for training of the intruder detection machine learning model.

In operation, the IDS 102 may monitor data traffic associated with the computing device 104. The data traffic may originate from the plurality of source devices 106 coupled to the computing device 104. The IDS 102 may then analyze the data traffic using an intruder detection machine learning model to identify an anomalous data pattern. Once the anomalous data pattern is identified, the IDS 102 may identify an anomalous source device from the plurality of source devices 106 corresponding to the anomalous data pattern. Subsequently, the IDS 102 may generate a notification indicative of a potential security breach associated with the anomalous source device. The manner in which the intrusion detection is facilitated in computing devices onboard the aircraft is further described in conjunction with the forthcoming figures.

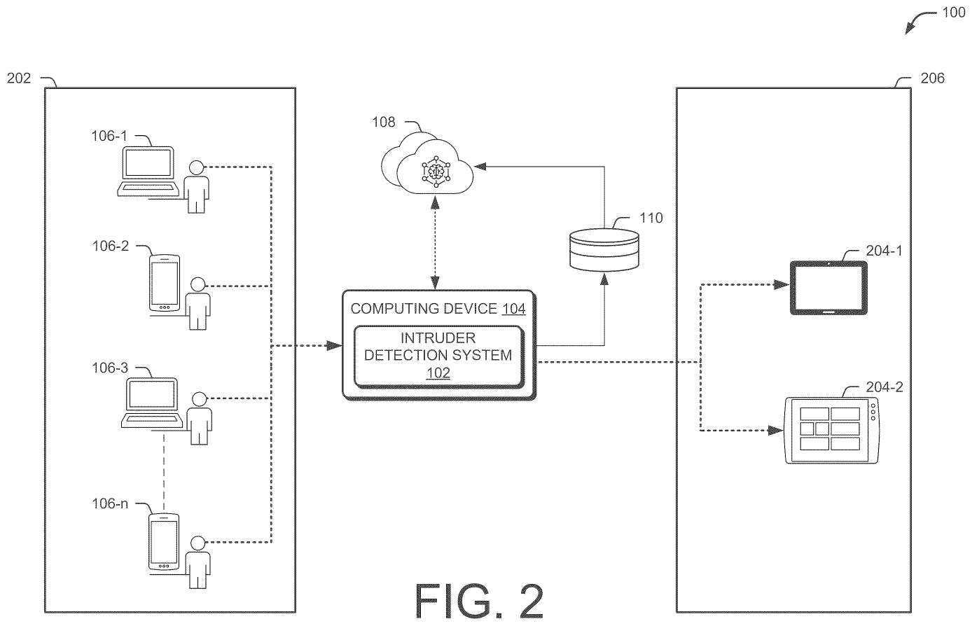

FIG. 2 illustrates an environment 100 for implementing the IDS 102, in accordance with another example of the present subject matter. The environment 100 may include the computing device 104 and the plurality of source devices 106 connected to the computing device 104. In an example, the computing device 104 may be the AP for providing internet connectivity to at least one user device present within a cabin domain 202 of the aircraft. The AP may work in conjunction with the network gateway, which utilizes various technologies such as satellite communication terminals and specialized in-flight connectivity systems to establish internet connectivity for the aircraft. The network gateway may then distribute this connectivity to the AP, which in turn provides wireless access to the at least one user device within the cabin domain 202 when the aircraft is airborne. Examples of specialized in-flight connectivity systems may include, but are not limited to, Air-to-ground (ATG) systems which use ground-based cellular networks specially designed for aircraft connectivity, Hybrid air-to-ground and satellite systems that can switch between terrestrial and satellite networks for optimal coverage, beam-forming antenna systems that can track and connect to multiple satellites simultaneously for improved bandwidth and reliability, Phased array antennas that can electronically steer connections to satellites without moving parts, Optical air-to-ground systems using laser technology for high-speed data transmission between aircraft and ground stations, and Networked ATG systems that use a mesh of aircraft to relay data, extending coverage areas.

In an example, the AP may support multiple wireless communication protocols to accommodate various types of user devices and connectivity requirements within the aircraft cabin. The AP may be configured to manage network traffic, implement security protocols, and optimize bandwidth allocation among connected devices.

In the example, the plurality of source devices 106 may be the at least one user device present within the cabin domain 202. The manner in which the computing device 104 and the plurality of source devices are coupled is explained in conjunction with FIG. 1 and is not reproduced for the sake of brevity. Further, for the sake of clarity, the computing device 104 and the plurality of source devices 106 has been hereinafter referred to as the AP 104 and the at least one user device 106, respectively.

The environment 100 may further include devices 204-1 and 204-2 present within a cockpit domain 206 of the aircraft. Examples of the devices 204-1 and 204-2 may include, but are not limited to, FMS and EFB. In an example, the AP 104 may also provide internet connectivity to the devices 204-1 and 204-2. In the example, the AP 104 may be utilized to provide flight operation data to at least one device, such as the device 204-1, where the flight operation data is usable for managing flight operations of the aircraft. The flight operation data may include avionics data being received from various avionics systems onboard the aircraft and real-time weather and air traffic data being received from various aviation cloud services. For the ease of reference, the at least one device 204-1 has been referred to as the at least one device 204, hereinafter.

Further, the environment 100 may include the aviation cloud 108 connected to the AP 104. In an example, the aviation cloud 108 may host the intruder detection machine learning model to analyze data traffic associated with the AP 104 and identify an anomalous data pattern from the data traffic. In another example, instead of being hosted on the aviation cloud 108, the intruder detection machine learning model may be trained on the aviation cloud 108 and deployed on the AP 104.

The environment 100 may further include the data repository 110 communicatively coupled to the AP. In the example, to train the intruder detection machine learning model, the historical data traffic metrics may be collected from the AP 104 available onboard the aircraft, along with other similar APs onboard different aircrafts and stored in the data repository 110. The historical data traffic metrics may then be utilized to train the intruder detection machine learning model. The manner in which the intruder detection machine learning model is trained is explained in conjunction with FIG. 1 and is not reproduced for the sake of brevity.

In operation, the IDS 102 may monitor data traffic associated with the AP 104. The data traffic may originate from the at least one user device 106 present within the cabin domain 202. The IDS 102 may then analyze the data traffic using an intruder detection machine learning model to identify an anomalous data pattern. Once the anomalous data pattern is identified, the IDS 102 may identify an anomalous user device from the at least one user device 106 corresponding to the anomalous data pattern. Subsequently, the IDS 102 may generate a notification indicative of a potential security breach associated with the anomalous source device.

In an example, the IDS 102 may then transmit the notification indicative of the potential security breach to at least one device 204 present within the cockpit domain 206, thereby alerting the at least one device 204 not to rely on the flight operation data received via the AP 104 during current flight operation of the aircraft. In the example, the IDS 102 may obtain the flight operation data for a predetermined time period prior to identification of the anomalous data pattern. The predetermined time period may be determined based on a duration of communication session between the anomalous source device and the AP. The IDS 102 may then compare the flight operation data with previous flight operation data obtained during the predetermined time period to determine that the previous flight operation data is tampered. The IDS 102 may then replace the previous flight operation data with the flight operation data. Subsequently, the IDS 102 may transmit another notification to the at least one device 204 for using the flight operation data during the current flight operation.

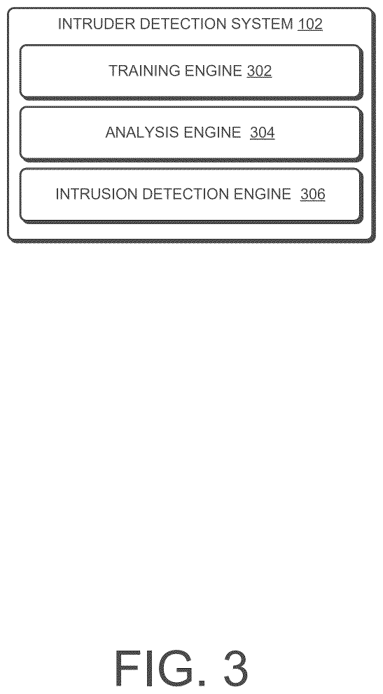

FIG. 3 illustrates schematics of the IDS 102, in accordance with an example of the present subject matter. In an example, the IDS 102 may include a training engine 302 to receive the training dataset including the historical data traffic metrics associated with the computing device 104 and the anomalous data patterns associated with the historical data traffic metrics. The training engine 302 may then utilize the training dataset to train the intruder detection machine learning model for identifying an anomalous data usage pattern.

The IDS 102 may further include an analysis engine 304 coupled to the training engine 302. In an example, the analysis engine 304 may monitor the data traffic associated with the computing device 104, where the data traffic originates from the plurality of source devices 106 coupled to the computing device 104. The analysis engine 304 may then analyze the data traffic using the intruder detection machine learning model to identify the anomalous data pattern from the data traffic. Once the anomalous data pattern is identified, the analysis engine 304 may identify an anomalous source device from the plurality of source device 106 that corresponds to the anomalous data pattern.

The IDS 102 may further include an intrusion notification engine 306 coupled to the analysis engine 304 to generate a notification indicative of the potential security breach associated with the anomalous source device. In an example, the notification may include an identifier of the anomalous source device. In the example, the notification may be transmitted to at least one device 204 present within the cockpit domain 206 of the aircraft. Subsequently, the at least one device 204 may initiate a mitigation action to mitigate the potential security breach.

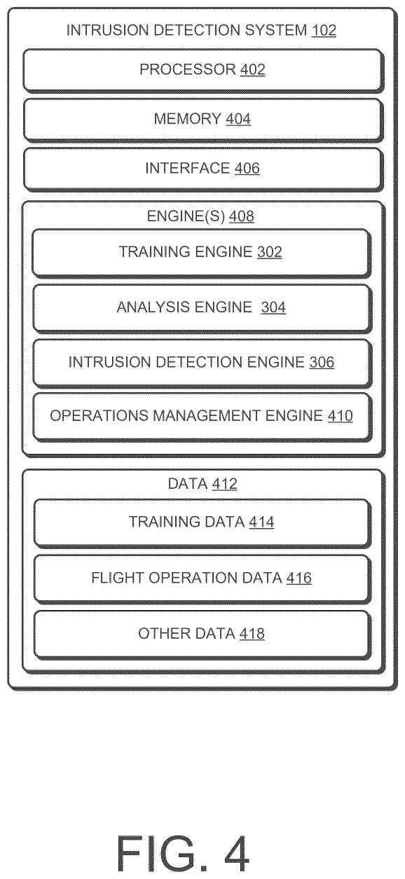

FIG. 4 illustrates the schematics of the IDS 102, in accordance with another example of the present subject matter. As illustrated, the IDS 102 may include a processor 402 and a memory 404 coupled to the processor 402. The functions of the various elements shown in the FIGs., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage.

The memory 404 may include any computer-readable medium including, for example, volatile memory (e.g., RAM), and/or non-volatile memory (e.g., EPROM, flash memory, etc.).

The IDS 102 may further include an interface 406. The interface 406 may allow the connection or coupling of the IDS 102 with one or more other devices, through a wired (e.g., Local Area Network, i.e., LAN) connection or through a wireless connection (e.g., Bluetooth®, WiFi). The interface 406 may also enable intercommunication between different logical as well as hardware components of the IDS 102.

The IDS 102 may further include engine(s) 408, where the engine(s) 408 may include the training engine 302, the analysis engine 304, the intrusion notification engine 306, and an operations management engine 410 coupled to the intrusion notification engine 306. In an example, the engine(s) 408 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the IDS 102 may include the machine-readable storage medium storing the instructions and the processing resource to execute the instructions. In other examples of the present subject matter, the machine-readable storage medium may be located at a different location but accessible to the IDS 102 and the processor 402.

The IDS 102 may further include data 412, that serves, amongst other things, as a repository for storing data that may be fetched, processed, received, or generated by the engine(s) 408. The data 412 may include training data 414, flight operation data 416, and other data 418. In an example, the data 412 may be stored in the memory 404.

In operation, the analysis engine 304 may monitor the data traffic associated with the computing device 104. As already explained, the data traffic may originate from the plurality of source devices 106 coupled to the computing device. The analysis engine 304 may then analyze the data traffic using the intruder detection machine learning model to identify an anomalous data pattern.

In an example, the training engine 302 may train the intruder detection machine learning model for detecting the anomalous data usage pattern. The training engine 302 may train the intruder detection machine learning model based on the training dataset created using the historical data traffic metrics associated with at least one computing device onboard at least one aircraft. In an example, to create the training dataset, the training engine 302 may acquire and store the historical data traffic metrics in the training data 414. The training engine 302 may then process the historical data traffic metrics to identify anomalous data patterns associated with the historical data traffic metrics. In an example, the training engine 302 may process the historical data traffic metrics based on the plurality of rules supplied by the flight safety crew to identify the anomalous data patterns.

The training dataset, among other things, may also include synthetic data traffic metrics and probable anomalous data patterns associated with the synthetic data traffic metrics. In an example, the training engine 302 may generate the synthetic data traffic metrics and the probable anomalous data patterns using the historical data traffic metrics and the anomalous data patterns. In the example, the training engine may then store the synthetic data traffic metrics and the probable anomalous data patterns in the training data 414. To generate the synthetic data traffic metrics and the probable anomalous data patterns, the training engine 302 may process the historical data traffic metrics and the anomalous data patterns using a generative machine learning model. Examples of the generative machine learning model include, but are not limited to, Variational Autoencoder (VAE) and Generative Adversarial Network (GAN).

Once the intruder detection machine learning model is trained based on the training data, the training engine 302 may deploy the intruder detection machine learning model on the IDS 102 to facilitate intrusion detection in the computing device 104.

The analysis engine 304 may then monitor data traffic associated with the computing device 104. The data traffic may originate from the plurality of source devices 106 coupled to the computing device 104. The analysis engine 304 may then analyze the data traffic using the intruder detection machine learning model to identify an anomalous data pattern. Once the anomalous data pattern is identified, the analysis engine 304 may identify an anomalous source device from the at least one source device corresponding to the anomalous data pattern. Subsequently, the intrusion notification engine may generate a notification indicative of a potential security breach associated with the anomalous source device.

In an illustrative example, the computing device 104 may be the FMS. In the example, the analysis engine 304 may monitor the data traffic associated with the FMS for identifying the anomalous data usage pattern. The data traffic associated with the FMS may include data coming from the plurality of source devices 106, such as the avionics system onboard the aircraft, the aviation cloud, and the ATC systems. The analysis engine 304 may analyze the data traffic associated with the FMS to identify an anomalous data pattern. For instance, there may be a situation where a malicious actor may unlawfully enter a cargo bay of the aircraft and physically intercept an avionics data bus passing through the cargo bay to transmit altered avionics data to the FMS.

In such a situation, the analysis engine 304 may utilize the intrusion detection machine learning model to detect an anomalous data pattern in the avionics data being received by the FMS. The intrusion detection machine learning model may analyse various characteristics of the incoming avionics data, such as frequency of transmission of data, type of data, and timing of transmission. The intrusion detection machine learning model may compare the characteristics against learned patterns of legitimate data traffic and identify anomalies such as unexpected data values, unusual transmission patterns, or inconsistencies with data from other sources. For example, the model may detect sudden changes in data transmission rates or patterns, unusual variations in sensor readings that don't align with historical norms, inconsistencies between different data streams that typically correlate, and unexpected commands or parameter changes.

In such a situation, the intrusion detection machine learning model may flag the data traffic as potentially anomalous. The analysis engine 304 may then identify an anomalous source device corresponding to the anomalous data pattern. For instance, in this example, the analysis engine 304 may analyse a source data field included in a header of at least one data packet constituting the avionics data to identify the anomalous source device. Subsequently, the intrusion notification engine may generate a notification indicative of a potential security breach associated with the anomalous source device.

In another illustrative example, the computing device 104 may be the AP providing internet connectivity to user devices present within the cabin domain of the aircraft. The analysis engine 304 may monitor the data traffic associated with the AP to identify anomalous data patterns. The data traffic may include data coming from various user devices connected to the AP within the cabin domain.

The analysis engine 304 may analyze the data traffic using the intrusion detection machine learning model to identify an anomalous data pattern. For instance, there may be a situation where a malicious actor onboard the aircraft attempts to exploit vulnerabilities in the AP to gain unauthorized access to restricted systems or sensitive information. In such a situation, the intrusion detection machine learning model may detect anomalous patterns in the data traffic from a particular user device.

The intrusion detection machine learning model may analyze various characteristics of the incoming data, such as data volume, connection attempts, types of requests, and timing patterns. The intrusion detection machine learning model may compare these characteristics against learned patterns of legitimate user behavior and identify anomalies that could indicate malicious activity. For example, the intrusion detection machine learning model may detect unusually high data transfer rates from a single user device, repeated attempts to access restricted network segments or services, unusual patterns of port scanning or probing, attempts to inject malformed packets or exploit known vulnerabilities, sudden changes in the typical behavior pattern of a user device.

If such anomalous patterns are detected, the intrusion detection machine learning model may flag the data traffic as potentially malicious. The analysis engine 304 may then identify an anomalous user device corresponding to the anomalous data pattern, for instance, by analyzing the source Internet Protocol (IP) address or Media Access Control (MAC) address associated with the suspicious traffic. Subsequently, the intrusion notification engine 306 may generate a notification indicative of a potential security breach associated with the anomalous user device. The notification may include details such as the device identifier, the nature of the suspicious activity, and the potential risks involved.

The operations management engine 410 may then initiate mitigation actions. The mitigation actions may include temporarily blocking the anomalous user device's access to the network, limiting bandwidth of the anomalous user device, or isolating the anomalous user device to a separate network segment to prevent potential spread of the threat.

The operations management engine 410 may further obtain the flight operation data for a predetermined time period prior to identification of the anomalous data pattern, where the flight operation data is usable for managing flight operations of the aircraft. The operations management engine 410 may then store the flight operation data in the flight operation data 416. In an example, the predetermined time period may be determined based on a duration of communication session between the anomalous source device and the AP. The operations management engine 410 may then compare the flight operation data with previous flight operation data obtained during the predetermined time period to determine that the previous flight operation data is tampered. The operations management engine 410 may obtain the previous flight operation data from the flight operation data 416. The operations management engine 410 may replace the previous flight operation data with the flight operation data and utilize the replaced flight operation data during flight operations of the aircraft.

In yet another illustrative example, the computing device 104 may be the EFB. The analysis engine 304 may monitor the data traffic associated with the EFB for identifying anomalous data usage patterns. The data traffic associated with the EFB may include data coming from a plurality of source devices 106, such as ground-based systems, onboard avionics systems, and external data providers.

The analysis engine 304 may analyze the data traffic using the intrusion detection machine learning model to identify an anomalous data pattern. For instance, there may be a situation where a malicious actor attempts to inject false or manipulated data into the EFB, potentially compromising flight safety or operational efficiency. In such a scenario, the intrusion detection machine learning model may detect unusual patterns in the incoming data streams. The model may analyze various aspects of the data including. but not limited to, data update frequency to detect unusually frequent or infrequent updates to flight charts, weather information, or other critical data; data consistency to detect discrepancies between different data sources, such as conflicting weather reports or navigation information; data format to detect unexpected changes in the structure or format of incoming data files; access patterns to detect unusual attempts to access or modify sensitive information stored on the EFB; and communication protocols to detect deviations from standard communication protocols used between the EFB and other aircraft systems or ground stations.

If any of the above-mentioned anomalies are identified, the intrusion detection machine learning model may flag the data traffic as potentially malicious. The analysis engine 304 may then identify the anomalous source device corresponding to the suspicious data pattern, for example, by analyzing the source identifiers or network addresses associated with the flagged data. Subsequently, the intrusion notification engine 306 may generate a notification indicative of a potential security breach associated with the identified anomalous source device. This notification may include details such as the type of anomaly detected, the affected data categories, and potential risks to flight operations.

The operations management engine 410 may then initiate appropriate mitigation actions. The mitigation actions may include isolating the affected data and preventing its integration into flight planning or navigation systems, alerting the flight crew to the potential data integrity issues, switching to backup data sources or reverting to the last known good configuration, and logging the incident for post-flight analysis and reporting to relevant authorities.

Additionally, the operations management engine 410 may compare the current flight operation data with previously stored data to identify any discrepancies that may have resulted from the potential intrusion. The comparison may help in assessing the extent of the security breach and potential impact of the security breach on flight operations of the aircraft.

In yet another illustrative example, the computing device 104 may be the network gateway. The network gateway may serve as a central hub, connecting the aircraft's internal systems with a variety of external communication channels, including satellite links, air-to-ground networks, and other specialized in-flight connectivity solutions.

In the example, the analysis engine 304 may monitor the data traffic passing through this network gateway for identifying anomalous data patterns. The analysis engine 304 may utilize the intrusion detection machine learning model to identify the anomalous data patterns. The intrusion detection machine learning model may analyse various aspects of the data traffic, including but not limited to, unexpected changes in data flow patterns or volumes, unusual connection attempts from external sources, atypical requests for access to internal aircraft systems, inconsistencies in data packet structures or headers, and suspicious encryption or decryption activities.

If such anomalies are detected, the intrusion detection machine learning model may flag the traffic as potentially malicious. The analysis engine 304 may then identify the source of the suspicious activity, which could be an external network, a specific IP address, or even a compromised internal system attempting to communicate through the gateway. Subsequently, the intrusion notification engine 306 may generate a notification detailing the potential security breach associated with the network gateway. This notification may include information such as the type of anomaly detected, the suspected origin of the threat, and potential risks to aircraft systems or data integrity.

The operations management engine 410 may then initiate appropriate mitigation actions. These could include temporarily isolating the gateway from certain external connections, rerouting critical communications through backup systems, or applying emergency security patches to the gateway's software.

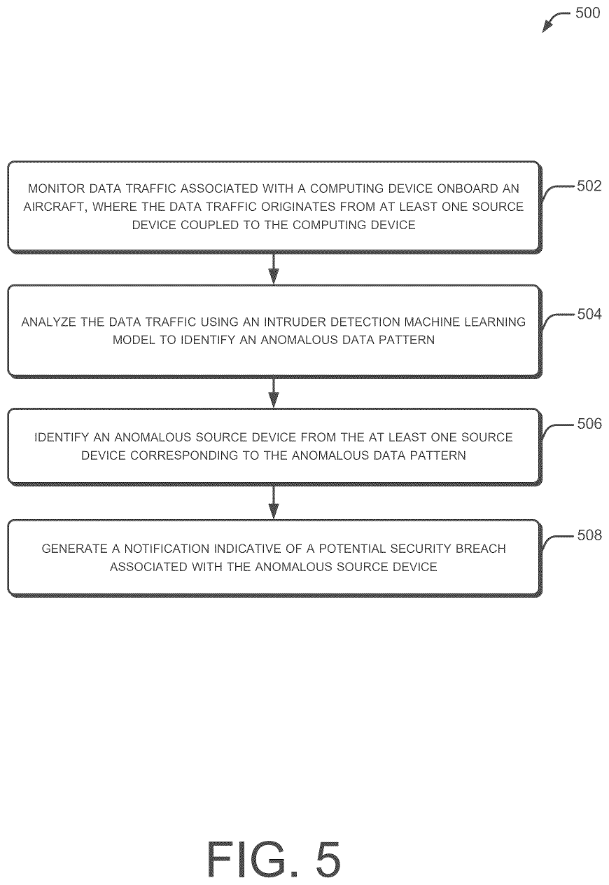

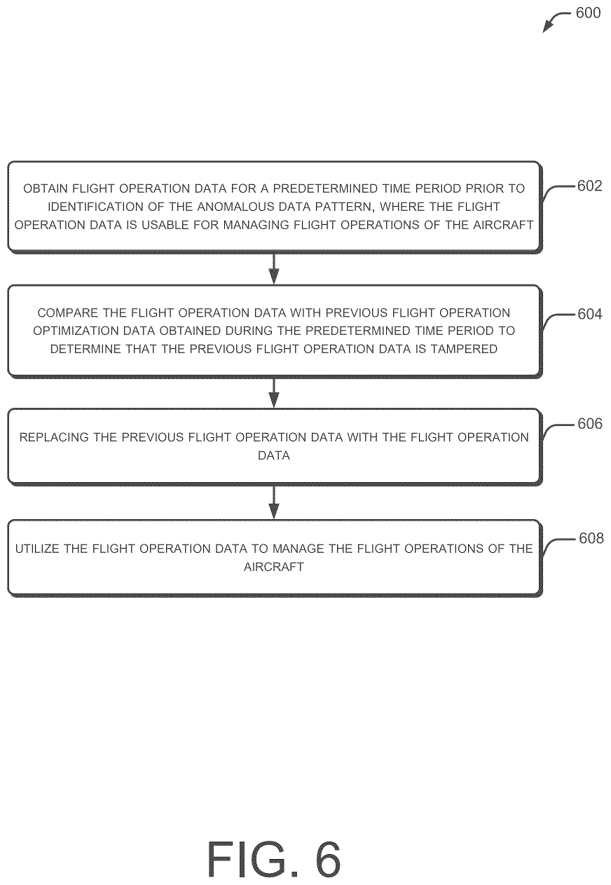

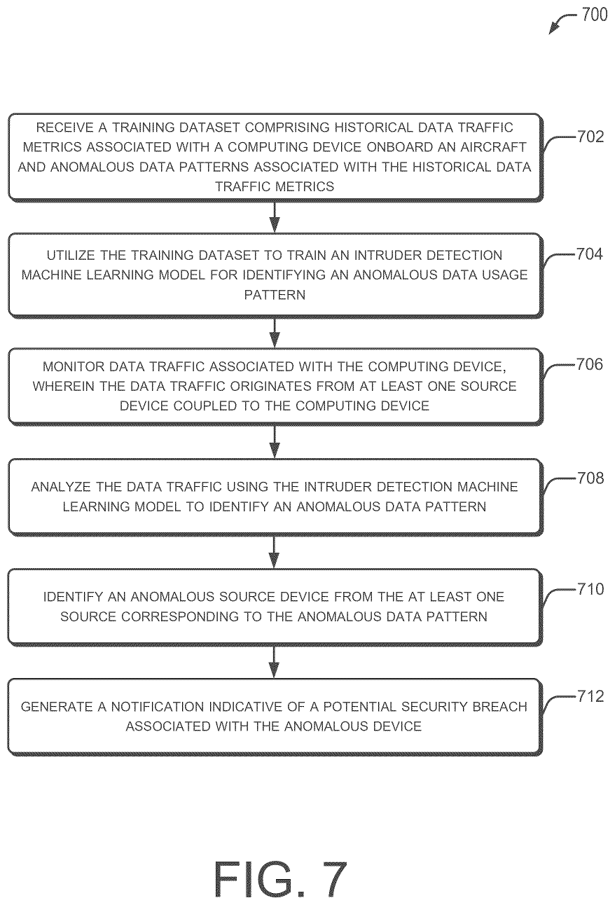

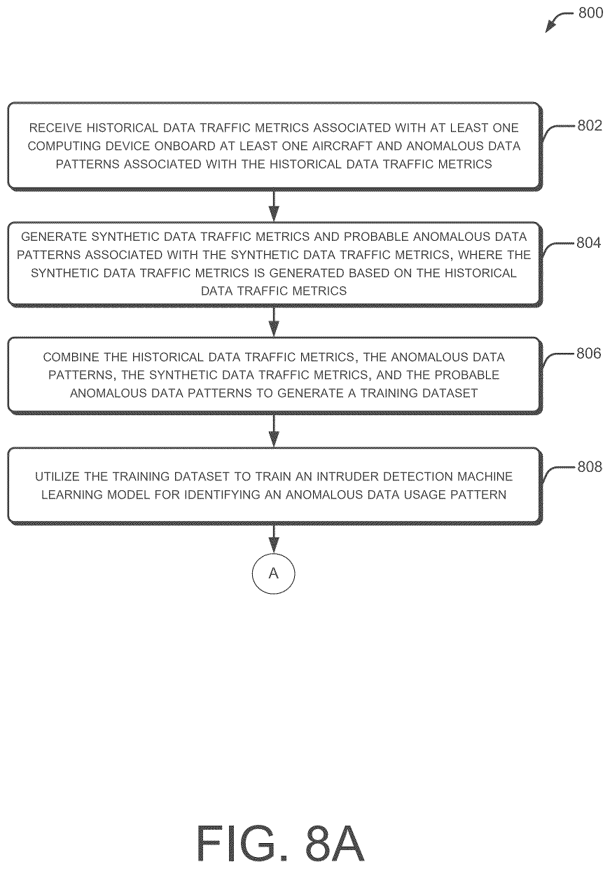

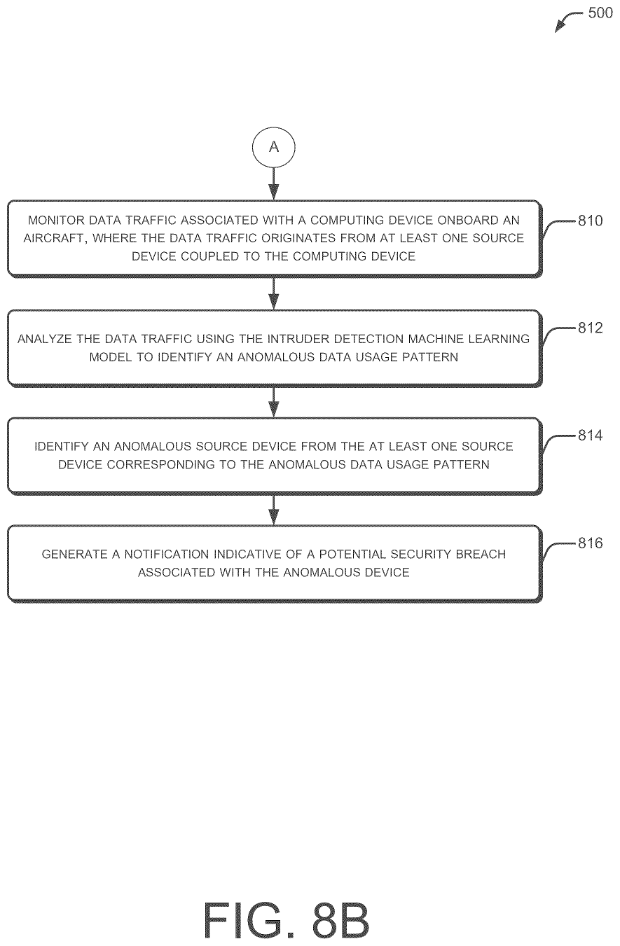

FIG. 5, FIG. 6, FIG. 7, and FIGS. 8A and 8B illustrate methods for detecting intrusion in the computing devices onboard the aircraft, in accordance with examples of the present subject matter. The order in which the method steps are described is not intended to be construed as a limitation, and any number of the described method blocks may be combined in any order to implement the methods, or an alternative method. Further, the methods 500, 600, 700, and 800 may be implemented by processing resource or computing device(s) through any suitable hardware, non-transitory machine-readable instructions, or combination thereof.

It may also be understood that methods 500, 600, 700, and 800 may be performed by programmed computing devices, such as the IDS 102. Furthermore, the methods 500, 600, 700, and 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 500, 600, 700, and 800 are described below with reference to the IDS 102, as described above; other suitable systems for the execution of these methods may also be utilized. Additionally, implementation of the method is not limited to such examples.

At block 502, data traffic associated with a computing device onboard an aircraft may be monitored. Examples of the computing device may include, but are not limited to, AP, FMS, and EFB. The data traffic may originate from at least one source device coupled to the computing device. In an example, the data traffic is monitored by the analysis engine 304.

At block 504, the data traffic may be analyzed using an intruder detection machine learning model to identify an anomalous data pattern. The intruder detection machine learning model may be trained using a training dataset comprising historical data traffic metrics and anomalous data patterns associated with the historical data traffic metrics. In an example, the data traffic is analyzed by the analysis engine 304.

At block 506, an anomalous source device corresponding to the anomalous data pattern is identified. The anomalous source device may be identified from the at least one source device. In an example, the anomalous source device may be identified by the analysis engine 304.

At block 508, a notification indicative of a potential security breach associated with the anomalous source device may be generated. The notification may also include an identifier of the anomalous source device. In an example, the notification indicative of the potential security breach may be generated by the intrusion notification engine 306.

Upon detection of the potential security breach and the anomalous source device, a mitigation action may be initiated. An example method for initiating the mitigation action in response to detection of the potential security breach is described in conjunction with FIG. 6.

In FIG. 6, at block 602, flight operation data for a predetermined time period prior to identification of the anomalous data pattern may be obtained. The flight operation data is usable for managing flight operations of the aircraft. The predetermined time period may be determined in various ways. For instance, the predetermined time period may be determined based on a duration of communication session between the anomalous source device and the computing device. In an example, the flight operation data may be obtained by the operations management engine 410.

At block 604, the flight operation data may be compared with previous flight operation data obtained during the predetermined time period to determine that the previous flight operation data is tampered. In an example, the comparison may be performed by the operations management engine 410.

At block 606, the previous flight operation data may be replaced with the flight operation data. In an example, the replacement may be performed by the operations management engine 410.

At block 608, the replaced flight operation data may be utilized during the flight operations of the aircraft. Further details related to the method for detecting intrusion in the computing devices onboard the aircraft is described in conjunction with FIG. 7.

In FIG. 7, at block 702, a training dataset comprising historical data traffic metrics associated with a computing device onboard an aircraft and anomalous data patterns associated with the historical data traffic metrics may be received. The training dataset, among other things, may also include synthetic data traffic metrics and probable anomalous data patterns associated with the synthetic data traffic metrics. The synthetic data traffic metrics and the probable anomalous data patterns may be generated based on the historical data traffic metrics and the anomalous data patterns. To generate the synthetic data traffic metrics and the probable anomalous data patterns, the historical data traffic metrics and the anomalous data patterns may be processed by a generative machine learning model. Examples of the generative machine learning model may include, but are not limited to, Variational Autoencoder (VAE) and Generative Adversarial Network (GAN). In an example, the training dataset may be received by the training engine 302.

At block 704, the training dataset may be utilized to train an intruder detection machine learning model for identifying an anomalous data usage pattern. In an example, the training may be performed by the training engine 302.

At block 706, data traffic associated with the computing device may be monitored. The data traffic may originate from at least one source device coupled to the computing device. In an example, the data traffic may be monitored by the analysis engine 304.

At block 708, the data traffic may be analyzed using the intruder detection machine learning model to identify an anomalous data pattern. In an example, the analysis may be performed by the analysis engine 304.

At block 710, an anomalous source device from the at least one source corresponding to the anomalous data pattern may be identified. In an example, the identification may be performed by the analysis engine 304.

At block 712, a notification indicative of a potential security breach associated with the anomalous source device may be generated. In an example, the notification may be generated by the intrusion notification engine 306. Upon detection of the potential security breach and the anomalous source device, a mitigation action may be initiated. An example method for initiating the mitigation action in response to detection of the potential security breach is described in conjunction with the FIG. 6 and is not reproduced for the sake of brevity.

In FIGS. 8A and 8B, at block 802, historical data traffic metrics associated with at least one computing device onboard at least one aircraft and anomalous data patterns associated with the historical data traffic metrics may be received. In an example, the method step 802 may be performed by the training engine 302.

At block 804, synthetic data traffic metrics and probable anomalous data patterns associated with the synthetic data traffic metrics may be generated. The synthetic data traffic metrics and the probable anomalous data patterns may be generated based on the historical data traffic metrics and the anomalous data patterns. In an example, the synthetic data traffic metrics and the probable anomalous data patterns may be generated by processing the historical data traffic metrics and the associated anomalous data patterns using the generative machine learning model. Examples of the generative machine learning model may include, but are not limited to, VAE and GAN. In an example, method step 804 may be performed by the training engine 302.

At block 806, the historical data traffic metrics, the anomalous data patterns, the synthetic data traffic metrics, and the probable anomalous data patterns may be combined to generate a training dataset. In an example, method step 806 may be performed by the training engine 302.

At block 808, the training dataset may be utilized to train an intruder detection machine learning model for identifying an anomalous data usage pattern. In an example, method step 808 may be performed by the training engine 302.

At block 810, data traffic associated with a computing device onboard an aircraft may be monitored. The data traffic may originate from at least one source device coupled to the computing device. In an example, method step 810 may be performed by the analysis engine 304.

At block 812, the data traffic may be analyzed using the intruder detection machine learning model to identify an anomalous data usage pattern. In an example, method step 812 may be performed by the analysis engine 304.

At block 814, an anomalous source device from the at least one source device corresponding to the anomalous data usage pattern may be identified. In an example, method step 814 may be performed by the analysis engine 304.

At block 816, a notification indicative of a potential security breach associated with the anomalous source device may be generated. In an example, method step 816 may be performed by the analysis engine 304. Upon detection of the potential security breach and the anomalous source device, a mitigation action may be initiated. An example method for initiating the mitigation action in response to detection of the potential security breach is described in conjunction with the FIG. 6 and is not reproduced for the sake of brevity.

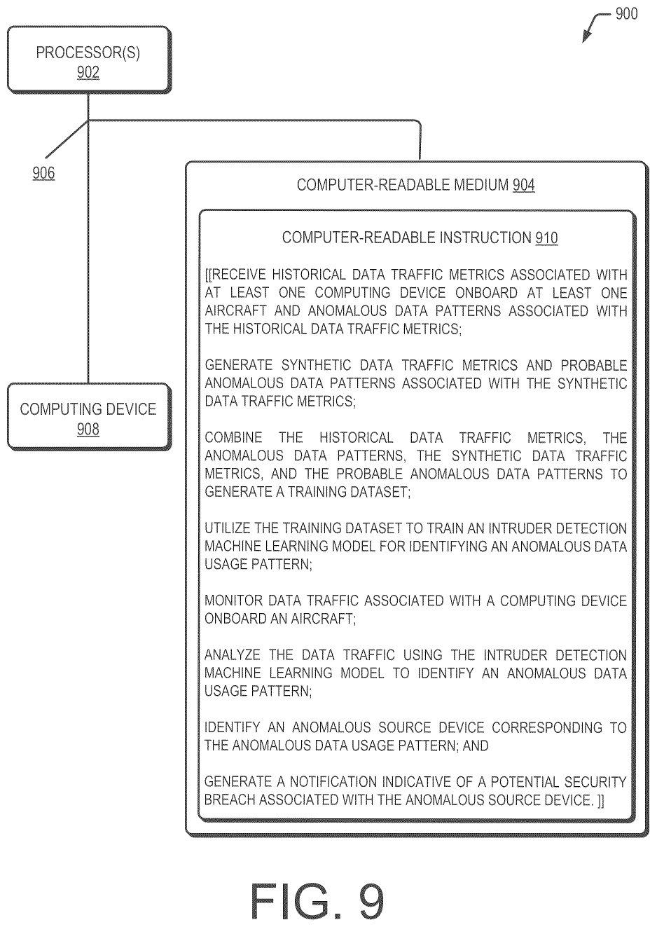

FIG. 9 illustrates a non-transitory computer-readable medium for detecting intrusion in the computing devices onboard the aircraft, in accordance with an example of the present subject matter.

In an example, the computing environment 900 includes processor 902 communicatively coupled to a non-transitory computer readable medium 904 through communication link 906. In an example implementation, the computing environment 900 may be for example, the IDS 102. In an example, the processor 902 may have one or more processing resources for fetching and executing computer-readable instructions from the non-transitory computer readable medium 904. The processor 902 and the non-transitory computer readable medium 904 may be implemented, for example, in the IDS 102.

The non-transitory computer readable medium 904 may be, for example, an internal memory device or an external memory. In an example implementation, the communication link 906 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 904 includes a set of computer readable instructions 910 which may be accessed by the processor 902 through the communication link 906 and subsequently executed for determining the anomaly in the operation of the asset. The processor(s) 902 and the non-transitory computer readable medium 904 may also be communicatively coupled to a computing device 908 over the network.

Referring to FIG. 9, in an example, the non-transitory computer readable medium 904 includes computer readable instructions 910 that cause the processor 902 to receive historical data traffic metrics associated with at least one computing device onboard at least one aircraft and anomalous data patterns associated with the historical data traffic metrics. The instructions 910 may then cause the processor 902 to generate synthetic data traffic metrics and probable anomalous data patterns associated with the synthetic data traffic metrics, where the synthetic data traffic metrics are generated based on the historical data traffic metrics and the anomalous data patterns. To generate the synthetic data traffic metrics and probable anomalous data patterns, the instructions 910 may cause the processor 902 to process the historical data traffic metrics and anomalous data patterns using a generative machine learning model. The generative machine learning model may include one of VAE and GAN.

Thereafter, the instructions 910 may cause the processor 902 to combine the historical data traffic metrics, the anomalous data patterns, the synthetic data traffic metrics, and the probable anomalous data patterns to generate a training dataset. The instructions 910 may then cause the processor 902 to utilize the training dataset to train an intruder detection machine learning model for identifying an anomalous data usage pattern.

The instructions 910 may then cause the processor to monitor data traffic associated with a computing device onboard an aircraft, where the data traffic originates from at least one source device coupled to the computing device. The instructions 910 may then cause the processor to analyze the data traffic using the intruder detection machine learning model to identify an anomalous data usage pattern.

Subsequently, the instructions 910 may cause the processor to to identify an anomalous source device from the at least one source device corresponding to the anomalous data usage pattern. The instructions 910 may then cause the processor to generate a notification indicative of a potential security breach associated with the anomalous source device.

In an example, the instructions 910 may cause the processor 902 to obtain flight operation data for a predetermined time period prior to identification of the anomalous data pattern, where the flight operation data is usable for managing flight operations of the aircraft. The instructions 910 may cause the processor 902 to determine the predetermined time period based on a duration of communication session between the anomalous source device and the computing device. The instructions 910 may then cause the processor 902 to compare the flight operation data with previous flight operation data obtained during the predetermined time period to determine that the previous flight operation data is tampered. Subsequently, the instructions 910 may cause the processor 902 to replace the previous flight operation data with the flight operation data and utilize the replaced flight operation data during flight operations of the aircraft.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
monitoring data traffic associated with a computing device onboard an aircraft, wherein the data traffic originates from at least one source device coupled to the computing device;
analyzing the data traffic using an intruder detection machine learning model to identify an anomalous data pattern, the intruder detection machine learning model being trained using a training dataset comprising historical data traffic metrics and anomalous data patterns associated with the historical data traffic metrics;
identifying an anomalous source device from the at least one source device corresponding to the anomalous data pattern; and
generating a notification indicative of a potential security breach associated with the anomalous source device.

2. The method of claim 1, wherein the training dataset further comprises synthetic data traffic metrics and probable anomalous data patterns associated with the synthetic data traffic metrics, the synthetic data traffic metrics and the probable anomalous data patterns being generated using the historical data traffic metrics and the anomalous data patterns.

3. The method of claim 1, wherein the computing device is one of an Electronic Flight Bag (EFB) and Flight Management System (FMS).

4. The method of claim 1, wherein the computing device is an Access Point (AP), and the at least one source device is at least one user device connected to the AP.

5. The method of claim 4, wherein the historical data traffic metrics comprises information associated with volume of data, type of data, an intended destination of data, frequency of transmissions of data, port access requests, login attempts to different communication channels of the computing device, or a combination thereof.

6. The method of claim 5, wherein the method further comprises:
obtaining flight operation data for a predetermined time period prior to identification of the anomalous data pattern, the flight operation data is usable for managing flight operations of the aircraft;
comparing the flight operation data with previous flight operation optimization data obtained during the predetermined time period to determine that the previous flight operation data is tampered; and
replacing the previous flight operation data with the flight operation data.

7. The method of claim 6, wherein the predetermined time period is determined based on a duration of communication session between the anomalous source device and the AP.

8. An Intruder Detection System (IDS) comprising:
a training engine to:
receive a training dataset comprising historical data traffic metrics associated with a computing device onboard an aircraft and anomalous data patterns associated with the historical data traffic metrics; and
utilize the training dataset to train an intruder detection machine learning model for identifying an anomalous data usage pattern;
an analysis engine coupled to the training engine to:
monitor data traffic associated with the computing device, wherein the data traffic originates from at least one source device coupled to the computing device;
analyze the data traffic using the intruder detection machine learning model to identify an anomalous data pattern; and
identify an anomalous source device from the at least one source corresponding to the anomalous data pattern; and
an intrusion notification engine coupled to the analysis engine to generate a notification indicative of a potential security breach associated with the anomalous source device.

9. The IDS of claim 8, wherein the training dataset comprises synthetic data traffic metrics and probable anomalous data patterns associated with the synthetic data traffic metrics, the synthetic data traffic metrics and the probable anomalous data patterns being generated based on the historical data traffic metrics and the anomalous data patterns.

10. The IDS of claim 9, wherein to generate the synthetic data traffic metrics and the probable anomalous data patterns, the training engine is to process the historical data traffic metrics and the anomalous data patterns using a generative machine learning model.

11. The IDS of claim 10, wherein the generative machine learning model is one of Variational Autoencoder (VAE) and Generative Adversarial Network (GAN).

12. The IDS of claim 8, wherein the computing device is one of an Electronic Flight Bag (EFB) and Flight Management System (FMS).

13. The IDS of claim 12, wherein the computing device is an Access Point (AP), and the at least one source device is at least one user device connected to the AP.

14. The IDS of claim 13, further comprising an operations management engine to:
obtain flight operation data for a predetermined time period prior to identification of the anomalous data pattern, the flight operation data being usable for managing flight operations of the aircraft;
compare the flight operation data with previous flight operation data obtained during the predetermined time period to determine that the previous flight operation data is tampered; and
replace the previous flight operation data with the flight operation data.

15. The IDS of claim 14, wherein the operations management engine is to determine the predetermined time period based on a duration of communication session between the anomalous source device and the AP.

16. A non-transitory computer readable medium comprising computer-readable instructions that when executed cause a processing resource of a computing device to:
receive historical data traffic metrics associated with at least one computing device onboard at least one aircraft and anomalous data patterns associated with the historical data traffic metrics;
generate synthetic data traffic metrics and probable anomalous data patterns associated with the synthetic data traffic metrics, the synthetic data traffic metrics and the probable anomalous data patterns being generated based on the historical data traffic metrics and the anomalous data patterns;
combine the historical data traffic metrics, the anomalous data patterns, the synthetic data traffic metrics, and the probable anomalous data patterns to generate a training dataset;
utilize the training dataset to train an intruder detection machine learning model for identifying an anomalous data usage pattern;
monitor data traffic associated with a computing device onboard an aircraft, wherein the data traffic originates from at least one source device coupled to the computing device;
analyze the data traffic using the intruder detection machine learning model to identify an anomalous data usage pattern; and
identify an anomalous source device from the at least one source device corresponding to the anomalous data usage pattern; and
generate a notification indicative of a potential security breach associated with the anomalous source device.

17. The non-transitory computer readable medium of claim 16, wherein to generate the synthetic data traffic metrics and probable anomalous data patterns, the instructions cause the processing resource to process the historical data traffic metrics and anomalous data patterns using a generative machine learning model, and the generative machine learning model being one of Variational Autoencoder (VAE) and Generative Adversarial Network (GAN).

18. The non-transitory computer readable medium of claim 16, wherein the computing device is an Access Point (AP), and the at least one source device is at least one user device connected to the AP.

19. The non-transitory computer readable medium of claim 18, wherein the instructions further cause the processing resource to:
obtain flight operation data for a predetermined time period prior to identification of the anomalous data pattern, the flight operation data is usable for managing flight operations of the aircraft;
compare the flight operation data with previous flight operation data obtained during the predetermined time period to determine that the previous flight operation data is tampered; and
replace the previous flight operation data with the flight operation data.

20. The non-transitory computer readable medium of claim 19, wherein the instructions cause the processing resource to determine the predetermined time period based on a duration of communication session between the anomalous source device and the AP.
